(19) United States
(12) Patent Application Publication
(10) Pub. No.: US 2007/0242460 A1
(43) Pub. Date: Oct. 18, 2007

(54) Beacon for the hearing impaired

(75) Inventor: Vijay Nagarajan, Hyderabad (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/406,567

(22) Filed: Apr. 18, 2006

(51) Int. Cl. F21V 19/02

(52) U.S. Cl. 362/285

(57) ABSTRACT

One version of a light beacon has a base, a light source, and a controller. The base is suitable for installing the light beacon within a building at a location so as emit light over a coverage area of the building. The light source is movably supported by the base. The controller controls the light source so that the light provided by the light source moves over the coverage area and so that the light provided by the light sources flashes. The light beacon may also have a lock that that determines an extent of movement of the light source.

### TECHNICAL FIELD OF THE INVENTION

The present invention relates to a light beacon that can be used, for example, to provide alarm warnings to the hearing impaired.

### BACKGROUND OF THE INVENTION

Warning lights are often used within buildings so that the hearing impaired can be alerted to emergency conditions such as a fire. Typically, a warning light includes a flashing bulb positioned horizontally within a reflector, and a lens may be used to spread the reflected light. The warning light may be powered by a battery source to ensure that it will have power in the event power to the building is disrupted.

Current warning lights, particularly those that are intended to act as alarms for the hearing impaired, have a number of problems. For example, current warning lights are stationary and, therefore, are not suitable for use in many situations such as where the hearing impaired reside in cubicle offices where the occupant may not be able to see the warning light announcing an alarm condition such as a fire. Even when the warning light is initially installed so that the occupant of the cubicle can see it, either the interior space of the cubicle changes over time so that the occupant who can initially see the warning light is moved out of the direct field of view of the warning light or the walls of cubicles are rearranged so that the coverage pattern of the warning light is no longer valid, wither or both of which might require repositioning the warning light or adding a new one. In order to preclude coverage problems arising from the cubicle environment, multiple warning lights are installed to cover the same area, which adds to the installation complexity and cost.

Also, current warning lights are not arranged to adequately capture the attention of the occupant in order to notify the occupant of the alarm condition. Occupants frequency sit in cubicles and are surrounded by a wide variety of lights. If the warning light is not sufficiently distinctive in such an environment, the occupant may not notice the operation of the warning light.

Moreover, the number of warning lights installed in a building space depends on the size of the building space. However, if the warning light could be properly directed and/or focused, the area of coverage of each light beam can be enlarged and, as a result, the existing warning lights can be more effective and/or fewer warning lights are required to adequately cover the space.

The present invention solves one or more of these or other problems.

### SUMMARY OF THE INVENTION

According to one aspect of the present invention, a light beacon comprises a base, a light source, and a controller. The base is suitable for installing the light beacon within a building at a location so as emit light over a coverage area of the building. The light source is movably supported by the base. The controller controls the light source so that the light provided by the light source moves over the coverage area.

According to another aspect of the present invention, a light beacon comprises a base, a light source, a controller, and an accessory. The base is suitable for installing the light beacon within a building at a location so as emit light over a coverage area of the building. The light source is supported by the base. The controller controls the light source. The accessory has an opening through which light from the light source is emitted to the coverage area, and the accessory is arranged to cause the light provided by the light source to flash over the coverage area.

According to still another aspect of the present invention, a light beacon comprises a base, a light source, and a controller. The base is suitable for installing the light beacon within a building at a location so as emit light over a coverage area of the building. The light source is movably supported by the base. The controller controls the light source so that the light provided by the light source moves over the coverage area and so that the light provided by the light sources flashes.

### BRIEF DESCRIPTION OF THE DRAWINGS

These and other features and advantages will become more apparent from a detailed consideration of the invention when taken in conjunction with the drawings in which:

FIG. 1 illustrates a light beacon configured in accordance with an embodiment of the present invention;

FIGS. 2a-2g illustrate possible accessories that can be used in connection with the light beacon of FIG. 1;

FIGS. 3-6 illustrate examples of applications of the light beacon of FIG. 1 to areas within a building; and,

FIG. 7 illustrates a controller for controlling the light beacon of FIG. 1.

### DETAILED DESCRIPTION

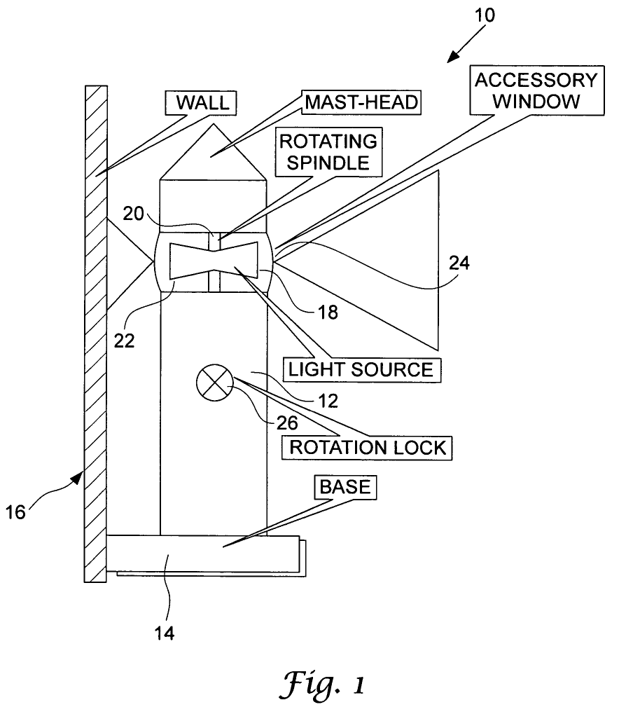

A light beacon 10 according to one embodiment of the present invention is shown in FIG. 1 and includes a mast 12 that is supported on a base 14 suitably attached to a wall 16 of a building in which the light beacon 10 is used. The base 14 should be attached to the wall 16 at a sufficiently elevated position so that the light emitted by the light beacon 10 during an alarm condition can be seen at all locations within the coverage area of the light beacon 10.

Alternatively, instead of using the base 14 to support the mast 12 at an elevated position on the wall 16, the mast 12 may be configured to hang from the ceiling at a height that is sufficient for the light emitted by the light beacon 10 during an alarm condition to be seen at all locations within the coverage area of the light beacon 10. As a further alternative, the mast 12 may be configured to stand on the floor in an Atrium hall at a height that is sufficient for the light emitted by the light beacon 10 during an alarm condition to be seen at all locations within the coverage area of the light beacon 10.

The light beacon 10 includes a light source 18 that is supported by a spindle 20 to the mast 12 within a light source compartment 22 of the mast 12. The light source compartment 22 is defined by an accessory window 24 that transmits light emitted by the light source 18 from the light source compartment 22 to the exterior of the light compartment so that the light may be seen by occupants within the coverage area of the light beacon 10.

The light source 18, for example, may comprise a light emitter that emits light directly to the coverage area or a combination of a light emitter and a reflector that directs and/or reflects light from the light emitter to the coverage area. The light emitter of the light source 18, for example, may comprise a spot or flood type light emitter such as a bulb and/or filament.

The spindle 20 may be a rotating or revolving spindle that permits the light emitter and/or reflector of the light source 18 to be rotated or revolved so that the light emitted by the light source 18 is given motion. If the light source 18 comprises a light emitter without a reflector, the light emitter is rotated or revolved by the spindle 20. However, if the light source 18 comprises both a light emitter and a reflector, either the light emitter, or the light reflector, or both may be rotated or revolved by the spindle 20.

The light emitted by the light beacon 10 may be white light. Alternatively, either the accessory window 24 itself or a lens or other material between the light source 18 and the accessory window 24 may be given a suitable tint so that the light emitted by the light beacon 10 is of a suitable color. As a still further alternative, a disc or other structure between the light source 18 and the accessory window 24 can support a plurality of individually selectable intermediate windows each having a different color. As yet a further alternative, the light emitter of the light source 18 can be controlled so that it emits a selectable wavelength associated with a corresponding light color. Accordingly, a particular color can be selected depending on the current stage of the alarm condition or otherwise.

The mast 12 also supports a lock 26 that is accessible to a user and that determines the extent of rotation of the spindle 20 carrying the light source 18. For example, the lock 26 may be adjusted to lock the light source 18 (and/or reflector) in a fixed position so that the light emitted by the light beacon 10 is not permitted motion. As an alternative or additional example, the lock 26 can be set to any selectable amount of rotation or revolution up to and/or including 360° of rotation or revolution.

As shown in FIG. 1, the light beacon 10 has the appearance of a lighthouse. However, the light beacon 10 may be given any other desirable appearance.

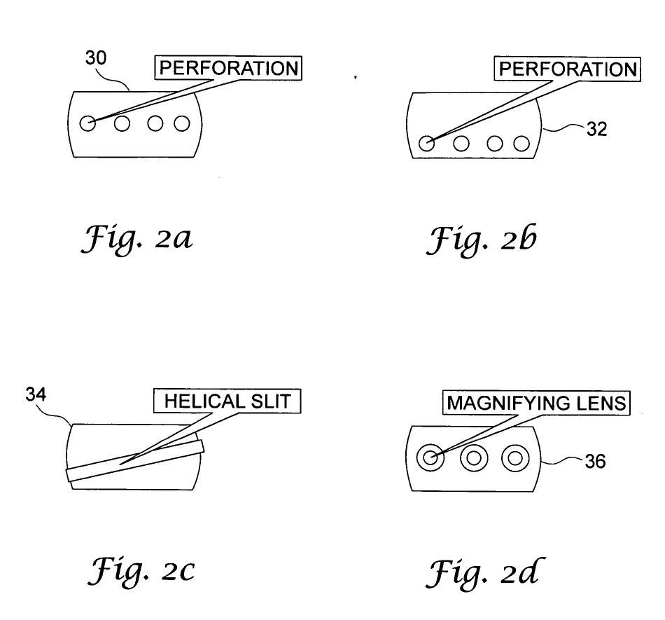

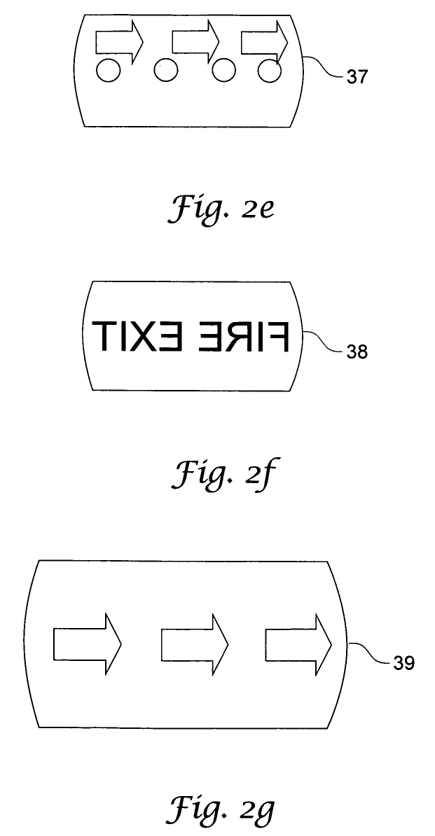

FIGS. 2a-2g illustrate possible accessories that can be used in connection with the accessory window 24. For example, these accessories can be used as the accessory window 24, they can be used as a cover over an exterior surface of the accessory window 24, they can be used as a cover over an interior surface of the accessory window 24, etc.

Accordingly, as shown in FIG. 2a, an accessory 30 may have perforations or windows that cause the light emitted by the light beacon 10 to flash as the light source 18 and/or associated reflector is rotated or revolved.

As shown in FIG. 2b, an accessory 32 may have perforations or windows that are lower compared to the perforations of the accessory 30. In this manner, the operation of the accessory 32 is similar to the operation of the accessory 30 except that the light is directed through differently angled plane.

As shown in FIG. 2c, an accessory 34 may have a slit to give the motion of the light emitted by the light beacon 10 a vertical and wells as a horizontal component.

As shown in FIG. 2d, an accessory 36 may be provided with a plurality of magnifying lens to periodically brighten or converge the light as the light is in motion. Each of the magnifying lens may be variably controlled so that magnifying lenses variable brighten or converge the light as light passes from the light source 18 through the lenses. Alternatively, the accessory 36 may be provided with a single magnifying lens or with a single variable magnifying lens.

As shown in FIG. 2e, an accessory 37 may have perforations or windows that cause the light emitted by the light beacon 10 to flash as the light source 18 and/or associated reflector is rotated or revolved as in the case of the accessories 30 and 32. In addition, the accessory 37 may have perforations or windows in the shape of arrows that cause light arrows to be sequentially projected so as to direct occupants to an appropriate exit.

As shown in FIG. 2f, an accessory 38 may have perforations or windows in the form of instructions that direct occupants to an appropriate exit.

As shown in FIG. 2g, an accessory 39 may have perforations or windows in the shape of arrows that cause light arrows to be sequentially projected so as to direct occupants to an appropriate exit.

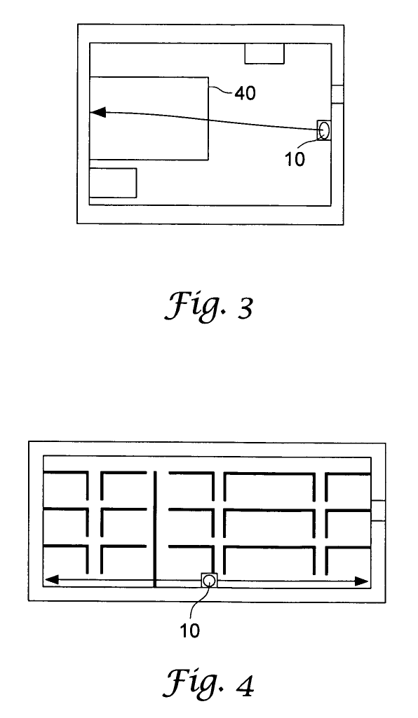

The light beacon 10 can be used in various spaces throughout a building. For example, as shown in FIG. 3, the light beacon 10 may be mounted so that the light emitted by the light beacon 10 is directed to a fixed location such as the head of a bed 40. Accordingly, the light from the light beacon 10 can be made to shine directly in the eyes of the occupant. In this connection, the light beacon 10, if desired, may be operated in a non-motion or fixed mode and/or with repetitive energization or with a variable lens controlled so at to cause the light emitted by the light beacon 10 to flash. In this case, either the light beacon 10 is not provided with the ability to move the light that it emits or the lock 26 is set to prevent motion of the emitted light.

The light beacon 10 can be elevated high enough so that it covers areas partitioned into cubicles as shown in FIG. 4. In this use, it may be desirable to operate the light beacon 10 so that its light moves across the entire area.

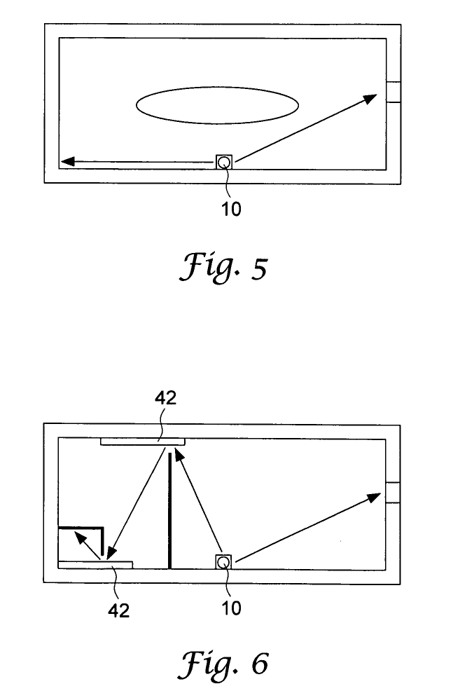

As shown in FIG. 5, the light beacon 10 can be operated with a motion that points the way to an exit from the coverage area.

As shown in FIG. 6, mirrors 42 can be used to extend the coverage of the light beacon 10. Alternatively, multiple instances of the light beacon 10 can be used to ensure that building areas are adequately covered.

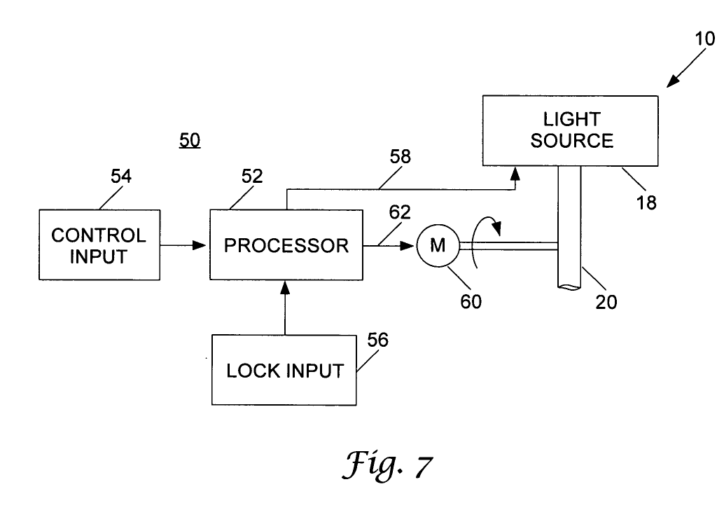

As shown in FIG. 7, a controller 50 may be provided according to an embodiment of the present invention for controlling the light beacon 10 so as to provide a warning of an alarm or other condition. The controller 50 includes a processor 52 that receives a control input 54 that is used to initiate operation of the light beacon 10.

The control input 54 may receive a signal that is manually initiated by an attendant of the building in which the light beacon 10 is located. Alternatively or additionally, the control input 54 may receive a signal that is automatically initiated by an alarm sensor. As a further alternative or additional embodiment, the control input 54 may receive a signal that is remotely generated by a master supervisory alarm system located within or without the building in which the light beacon 10 is located. Other alternative or additional embodiments are possible.

The processor 52 receives a lock input 56 that is associated with the lock 26 and that determines the extent of rotation or revolution of the light beacon 10. As discussed above, the light beacon 10 may be operated without rotation or revolution, in which case the lock 26 controls the lock input 56 so that the extent of rotation or revolution of the light beacon 10 is 0°. For example, for an installation such as that shown in FIG. 3, the lock input 56 may be set by the lock 26 so as prevent rotation or revolution of the light beacon 10 and thereby direct the light from the light beacon 10 to a fixed location.

Alternatively or additionally, the light beacon 10 may be operated with rotation or revolution, in which case the lock 26 controls the lock input 56 so that the extent of rotation or revolution of the light beacon 10 is greater than 0° and could be up to 360° of rotation or revolution. For example, for an installation such as that shown in FIG. 4 where the light beacon 10 is located against a wall, the lock input 56 may be set so as control rotation or revolution of the light beacon 10 through a 180° arc. As a further alternative or additional embodiment, the lock input 56 may be set by the lock 26 so as control rotation or revolution of the light beacon 10 through less than a 180° arc as shown in FIGS. 5 and 6. As a still further alternative or additional embodiment, if the light beacon 10 were located in the middle of its coverage area, the lock input 56 may be set by the lock 26 so as control rotation or revolution of the light beacon 10 through 3600. However, it should be understood that the light beacon 10 can be operated with any amount of rotation or revolution in any location.

The lock input 56 may be provided by a register, a memory, a switch or any other apparatus that is operated by the lock 26 and that is capable of indicating to the processor 52 the extent of rotation or revolution of the light beacon 10. For example, the lock 26 may be operated so as to store motion limits in the lock input 56. The processor 52 may be a computer, an ASIC, a programmable gate array, or any other device that is capable of controlling the light beacon 10 as described herein.

When the processor 52 receives an instruction over the control input 54 to initiate operation of the light beacon 10, it turns on the light source 18 over a control line 58 and it drives a motor 60 over a control line 62 to move the spindle 20 in accordance with the motion defined by the lock input 56.

The processor 52 may be arranged to control the light source 18 over the control line 58, such as by repetitively energizing and de-energizing the light source 18, so that the light from the light source 18 flashes or strobes. Alternatively, accessory windows such as those described above in connection with FIGS. 2a, 2b, and 2d may be provided so that the light from the light source 18 flashes and/or moves in any desired pattern.

Certain modifications of the present invention have been discussed above. Other modifications of the present invention will occur to those practicing in the art of the present invention. For example, as described above, a light emitter and/or a reflector of the light source 18 is rotated or revolved by the spindle 20 in order to produce motion of the light emitted by the light beacon 10. Instead, the light source 18 and/or reflector may be fixed so that they do not move and instead a variable lens can be used to impart a flashing or motion effect to the light emitted by the light beacon 10. Such a lens can be used in connection a movable spindle such as when the spindle is locked to a fixed position.

Also, various accessories are described above for use with the light beacon 10. Alternatively, accessories with arrow shaped openings can be used with the light beacon 10. For example, such arrow shaped openings when illuminated may be arranged to point to the closest exit. Additionally, when the light emitted by the light beacon 10 is given motion as discussed above, the arrow shaped openings will appear in sequence directing occupants to the nearest exit.

Moreover, as described above in connection with FIG. 7, the lock input 56 operates electronically to define the motion of the light source 18. Alternatively or additionally, the lock input 56 may be provided as a mechanical lock such as limits that limit the amount of rotation or revolution of the light beacon 10.

Furthermore, the lock input 56 may be arranged to define motions other that simple rotation or revolution. Accordingly, the light emitted by the light beacon 10 can be controlled in complex patterns.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

What is claimed is:

1. A light beacon comprising:
a base suitable for installing the light beacon within a building at a location so as emit light over a coverage area of the building;
a light source movably supported by the base; and,
a controller that controls the light source so that the light provided by the light source moves over the coverage area.

2. The light beacon of claim 1 further comprising a lock that determines an extent of movement of the light source.

3. The light beacon of claim 2 wherein the lock is settable to fix the light source against movement.

4. The light beacon of claim 2 wherein the lock is settable to permit movement of the light source through movement up to 360°.

5. The light beacon of claim 4 wherein the lock is also settable to fix the light source against movement.

6. The light beacon of claim 2 wherein the lock comprises a mechanical lock.

7. The light beacon of claim 2 wherein the lock comprises an electronic lock.

8. The light beacon of claim 1 wherein the controller includes a motor that is energized to move the light emitted by the light source.

9. The light beacon of claim 8 wherein the motor is arranged to drive a light emitter of the light source.

10. The light beacon of claim 8 wherein the motor is arranged to drive a reflector of the light source.

10. The light beacon of claim 8 wherein the motor is arranged to drive a light emitter and a reflector of the light source.

11. The light beacon of claim 8 wherein the motor is arranged so that its range of motion is mechanically controlled.

12. The light beacon of claim 8 wherein the motor is arranged so that its range of motion is electronically controlled.

13. The light beacon of claim 1 wherein the controller is arranged to move the light from the light source so as to direct occupants toward an exit.

14. The light beacon of claim 1 further comprising an accessory having a slanted opening to as to impart a vertical component to the movement of the light from the light source.

15. The light beacon of claim 1 further comprising an accessory having an arrow shaped opening through which light from the light source is emitted.

16. The light beacon of claim 1 further comprising an accessory having an opening in the shape of instructions directing occupants to an exit.

17. The light beacon of claim 1 wherein the controller is arranged to control the light source so that the light provided by the light source moves with a horizontal component.

18. The light beacon of claim 17 wherein the controller is arranged to control the light source so that the light provided by the light source moves with a vertical component.

19. A light beacon comprising:
a base suitable for installing the light beacon within a building at a location so as emit light over a coverage area of the building;
a light source supported by the base;
a controller that controls the light source; and,
an accessory that has an opening through which light from the light source is emitted to the coverage area, the accessory opening being arranged to cause the light provided by the light source to flash over the coverage area.

20. The light beacon of claim 19 wherein the accessory includes a plurality of perforations.

21. The light beacon of claim 19 wherein the accessory includes a plurality of lenses.

22. The light beacon of claim 19 wherein the accessory includes a variable lens.

23. The light beacon of claim 19 wherein the accessory includes an arrow shaped opening.

24. A light beacon comprising:
a base suitable for installing the light beacon within a building at a location so as emit light over a coverage area of the building;
a light source movably supported by the base; and,
a controller that controls the light source so that the light provided by the light source moves over the coverage area and so that the light provided by the light sources flashes.

25. The light beacon of claim 24 further comprising a lock that sets an extent of movement of the light source.

26. The light beacon of claim 24 wherein the controller includes a motor that is energized to move the light emitted by the light source.

27. The light beacon of claim 24 wherein the controller is arranged to move the light from the light source so as to direct occupants toward an exit.

28. The light beacon of claim 24 further comprising an accessory that is arranged to modify light emitted by the light source.

29. The light beacon of claim 28 wherein the accessory has a slanted opening to as to impart a vertical component to the movement of the light from the light source.

30. The light beacon of claim 28 wherein the accessory has an arrow shaped opening.

31. The light beacon of claim 28 wherein the accessory has an opening in the shape of instructions directing occupants to an exit.

32. The light beacon of claim 28 wherein the accessory is arranged to cause the light provided by the light source to flash over the coverage area.

33. The light beacon of claim 28 wherein the accessory includes a plurality of perforations.

34. The light beacon of claim 28 wherein the accessory includes a plurality of lenses.

35. The light beacon of claim 28 wherein the accessory includes a variable lens.

36. The light beacon of claim 28 further comprising a lock that sets an extent of movement of the light source.
